(19) United States
(12) Patent Application Publication
(10) Pub. No.: US 2022/0207544 A1
(43) Pub. Date: Jun. 30, 2022

(54) POI TRACKING ANALYSIS SYSTEM AND PEOPLE FLOW SYSTEM

(71) Applicant: Spatial Topology Co., Ltd., Taipei (TW)

(72) Inventors: Shih-Chi LIN, Taipei (TW); Yen-Cheng CHEN, Taipei (TW)

(73) Assignee: Spatial Topology Co., Ltd., Taipei (TW)

(21) Appl. No.: 17/535,835

(22) Filed: Nov. 26, 2021

(30) Foreign Application Priority Data
Dec. 29, 2020 (TW) 109146719

(51) Int. Cl. G06Q 30/02; G06F 16/29

(52) U.S. Cl. CPC G06Q 30/0205; G06F 16/29

(57) ABSTRACT

The present invention provides a POI tracking analysis system, which comprises: a footprint tracking unit, for detecting user's footprint information, which includes a plurality of stay times of the user or a user's virtual object visiting record at different locations; a POI analysis unit, comparing the stay time (or the virtual object visiting record) at one of the locations in the footprint information, with a judgment threshold according to a point of interest at the location, for determining whether this one location is a point of interest of the user or not; and a historical information storage unit, storing each point of interest of the user. The present invention further provides a people flow analysis system, which determines a people flow status at each location according to the footprint information.

### BACKGROUND OF THE INVENTION

### 1. Field of the Invention

The present invention provides a point of interest tracking analysis system and a people flow analysis system. The systems determine the point of interest and the people flow status of multiple locations from the footprint information.

### 2. Description of Related Art

In the current point of interest (POI) determination technology, the technology depends on uploading the text, photos, videos, and even personal comments edited by netizen at a location, and depend on reading rate to determine the location as a POI. In the selection of POI, for example, a speed stick having a speeding photo record also becomes the POI through the reading rate.

However, no matter the POI is accumulated through a long time or become famous in a short time, using the above reading rate, uploading picture is hard to determine that the location is a real POI. For example, heating up a topic can generate a popular POI, but lack of interest later. The POI building way is hard to determine if the location is a stable POI, and hard to exclude that the location is a short time requirement.

### SUMMARY OF THE INVENTION

For the above problem, the present invention can provide a point of interest tracking analysis system to solve the above problem, through the technology provided by the present invention, the relation between the footprint and POI of a user can be instantly and precisely obtained. By the technology provided by the present invention, without disclosing the privacy of the user, the consumer interest and attribute classification of the user can be determined. The information can have multiple applications. For example, providing for business activities as a reference. Besides, when the system stores consumer interest and attribute classification of multiple users, after analysis, induction, and application, an economic, effective, and reducing waste of resources management effect can be achieved.

The present invention provides a point of interest tracking analysis system, including a footprint tracking unit, a point of interest (POI) analysis unit and a historical information storage unit. The footprint tracking unit is used for detecting a footprint information of a user. The footprint information is obtained by a wireless method. Wherein, an outdoor footprint information and an indoor information are included. The user can use a carrier having the present system to execute positioning judgment. In the process of detecting the footprint information, based on the location information, time information of the location, the multiple locations passed by the user and the stay time at each location can be determined. When the user stay for a longer time, the location is a corresponding POI (or, the footprint information can also include the virtual object visiting record at the location). The POI analysis unit compares a stay time or a virtual object visiting record of each location in the footprint information of each user with a judgment threshold corresponding to POI, and determining if the location is the POI of at least one user according to a comparing result. The historical information storage unit for storing the footprint information of the multiple users for applications of analysis, management, advice, judgment, assistance of POI.

In one embodiment, the point of interest includes commercial organizations, tourist attractions, public agencies, coordinates of transportation facilities, storage spaces in stores or warehouses.

In another embodiment, the present invention also provides a people flow analysis system, comprising: multiple footprint judgment units for respectively determining individual footprint information of multiple users, wherein the footprint information includes multiple locations and time information at each location of each of the multiple users; a historical information storage unit for storing the footprint information of the multiple; and a people flow analysis unit analyzing a people flow status at different time of each location according to the footprint information of the multiple users.

### BRIEF DESCRIPTION OF THE DRAWINGS

FIG. 1 is a schematic diagram of a point of interest tracking analysis system according to an embodiment of the present invention;

FIG. 2A is a schematic diagram of determining each location and stay time of each location in the footprint information according to an embodiment of the present invention;

FIG. 2B is a schematic diagram of determining each location and stay time of each location in the footprint information according to an embodiment of the present invention;

FIG. 3 is a schematic diagram of augmented reality object according to an embodiment of the present invention;

FIG. 4 is a schematic diagram of people flow system according to an embodiment of the present invention; and

FIG. 5 is a schematic diagram of people flow system according to an embodiment of the present invention.

### DETAILED DESCRIPTION OF THE PREFERRED EMBODIMENT

The technology content, features and effects can be clearly illustrated by the preferred embodiments and figures.

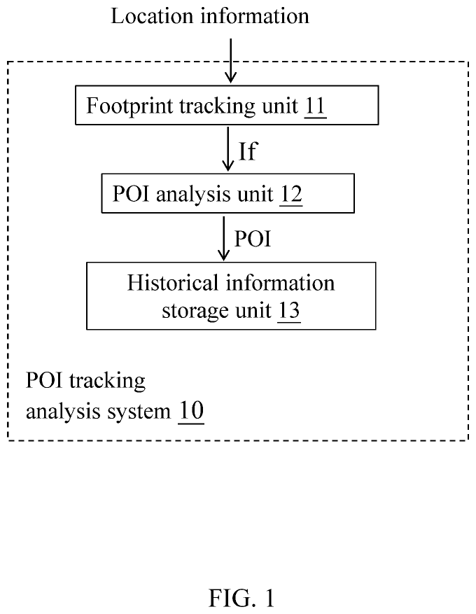

FIG. 1 shows a POI tracking analysis system 10. The system 10 includes a footprint tracking unit 11, a POI (Point of interest) analysis unit 12 and a historical information storage unit 13. The footprint tracking unit 11 is used for detecting the location information of a user in order to form footprint information (If). The footprint tracking unit 11 mainly obtains the location information of the user by a wireless method in order to obtain the footprint information (If).

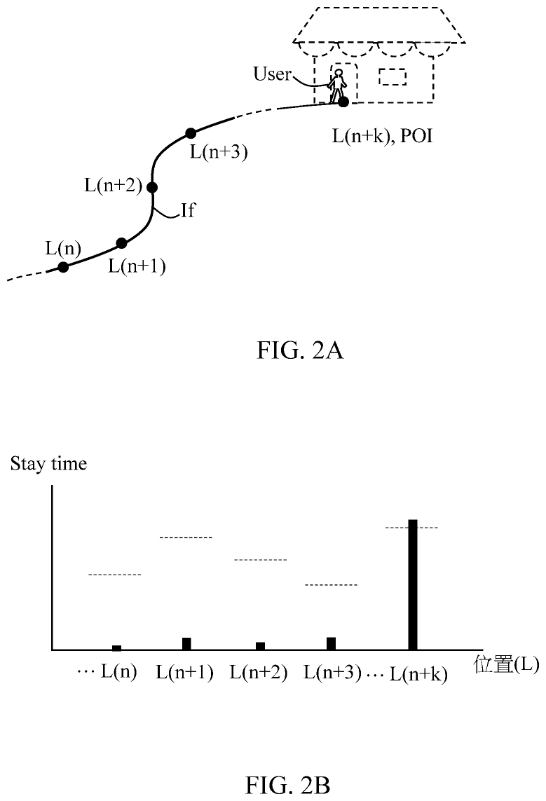

For example, the outdoor location information can be obtained by a Global Positioning System (GPS), a Universal Packet Radio Service (GPRS), the geomagnetic direction or the digital information of the cadastral material to determine the footprint information (If). The indoor location information can use various indoor wireless information such as Beacon, Bluetooth and WIFI to perform a position judgment in order to determine the footprint information (If). The user can use the smart phone, the touring machine and portable electronic device or the portable device having the present function to determine the location information. With reference to FIG. 2A, in the process of determining the footprint information (If), based on the location information and the time information at the detecting location to determine multiple locations and stay time of the multiple locations passed by the User. Wherein, each of the multiple locations L(n), L(n+1), L(n+2), L(n+3), . . . L(n+k) has a corresponding point of interest. When a stay time is longer, and when a touring machine is over a determining threshold value (as shown in FIG. 2B, the dotted line at the vertical coordinate at each location present the judgement threshold of corresponding point of interest, for example, the time required for basic activity, referring to the following embodiment for detail). The location can be regarded as a corresponding point of interest (referring to the following embodiment for detail).

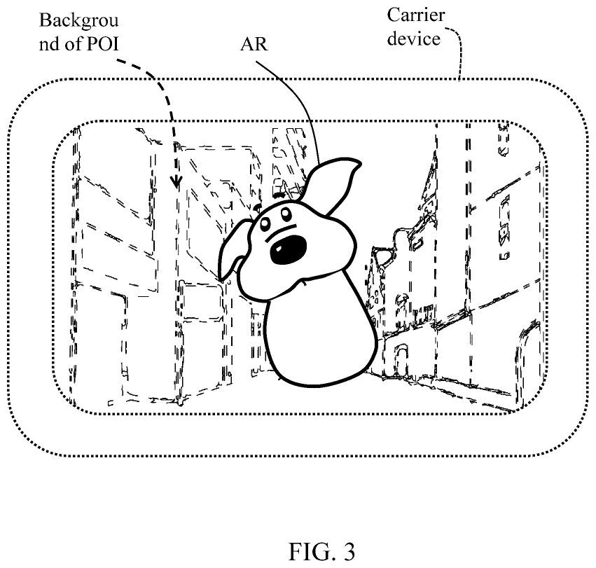

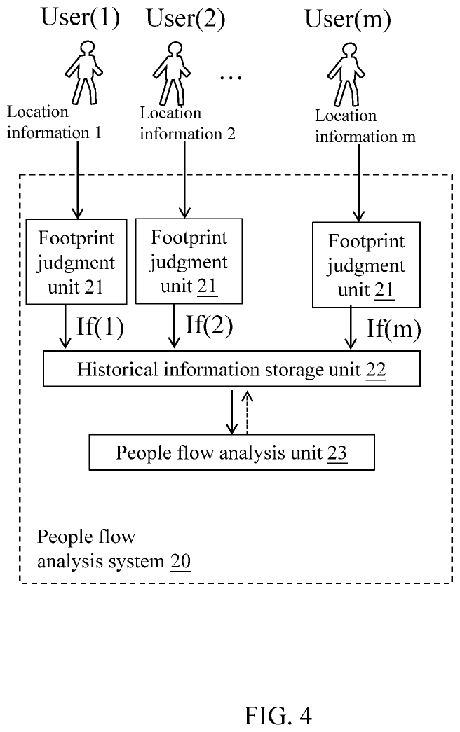

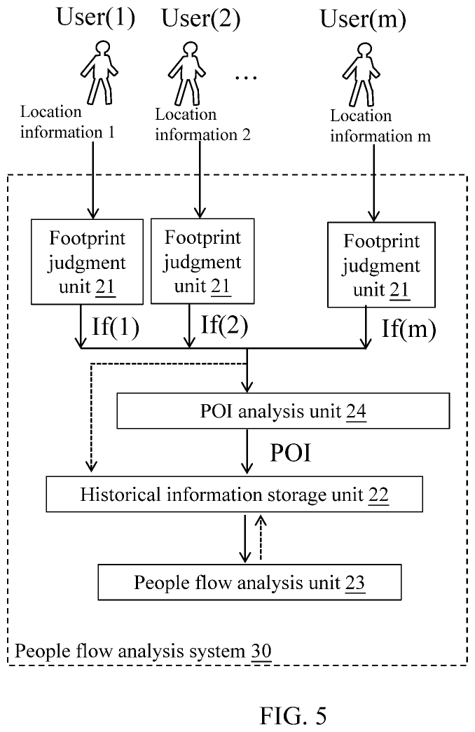

The footprint information (If) can also include a virtual object visiting record of the user at the location L. For example, an operation time, a reading record, a positive review, a photo record, a video reposting action, or a game operation record of an augmented reality object (AR) as shown in FIG. 3 about the point of interest. The POI analysis unit 12 compare the stay time or the operation record of the virtual object at each location L(n), L(n+1), L(n+2), L(n+3), . . . L(n+k) in the footprint information (If) with the threshold of the POI of L(n), L(n+1), L(n+2), L(n+3), . . . L(n+k), and determines which location belongs the POI of the user. Wherein, the judgement threshold will be illustrated in the following embodiment. The historical information storage unit 13 is used for storing the related information of the POI of the user for analysis, management, advice, judgment, assistance of the POI.

In one embodiment, types of the point of interest (POI) can include: commercial organizations, tourist attractions, public agencies, coordinates of transportation facilities, storage spaces in stores or warehouses, etc. The above commercial organization can be gas stations, department stores, supermarkets, stores, restaurants, hotels, convenience stores, hospitals, concert halls, performance halls, airports, MRT, exhibition halls, cinemas, beverage shops, clothing, gyms, etc. The above tourist attractions can be parks, historical sites, public toilets, museums, etc. The aforementioned public institutions may include: schools, arts and cultural centers, administrative agencies, etc. The above transportation facilities can be various stations, parking lots, speed cameras, speed limit signs, etc. In some games, the wireless signal source that will generate treasures, virtual objects can also be the POI. In some embodiment, a new type and location of POI can be built according to the requirement of the user. The information of POI can include name, address and type of POI. Wherein, the location information of the POI can be three-dimensional location information. The three dimensional location information can floor height, rooms, booths, exhibition points, addresses, storage tiers and storage locations (storage space for items in the warehouse) inside a building or geographic location (longitude, latitude, relative altitude, the relative altitude is, for example, altitude).

Besides, the three-dimensional location information can have other applications. For example, the height drops instantly at a high speed may be system vehicle missing, user falls, taking the elevator out of control and slide down. The system can determine if issue a warning or signal for help according to the situations.

The judgement threshold for determining the POI of each location has many embodiments. In one embodiment, the judgement threshold of POI can correspond to a required time for basic activity. For example, hand-crank beverage shop on the roadside, the required time for basic activity can include process beverage options, payment purchases, beverage making, etc. Wherein the required time for basic activity can be three to ten minutes. The judgement threshold can be defined as four minutes for stay time. When the user stay in the hand-crank beverage. That is, when the user stays in the hand-crank beverage over four minutes, the hand-crank beverage is the POI of the user. For another example, generally, the required time of basic activity for searching and looking books is longer, the required time for determining the store as the POI is longer. For example, the required time of basic activity is ten minutes. When the user stay in the bookstore more than ten minutes (the threshold is ten minutes), the bookstore can be determined as the POI of the user. Importantly, the different POI corresponds to different required time of basic activity. The required time of basic activity does not required to be the same. That is, the required time of basic activity of POI can be the same or different. The required time of basic activity described above is used as an example, not for limiting the embodiment way of POI of present invention.

In one embodiment, the operation record of the virtual object is an operation time operations, reading records, positive reviews, photo records, or reposts videos of the augmented reality objects of the POI. With reference to FIG. 3, when the User is close to the location of POI, the system will detect the location information, and provide an augmented reality object on the device to interactive with the user. When the user have one of the operation records, and the record is over the threshold (for example, operations, reading records are over a preset time; the number of operations photo records, or repost videos are over a preset number; or the positive evaluation is over a preset word count), determining that the location is the POI of the user. It should be noted that the augmented reality object (AR) is just schematic, not for limiting the scope of the present invention.

Besides, about the judgment threshold of the POI, in another embodiment, the multiple locations can correspond to a same virtual POI. The multiple locations belong to a same commercial organizations, tourist attractions, and public institutions. For example, campuses of many universities are spread on multiple locations. The locations are all belong to the virtual POI of the university. Another example, for many entertainment agency the ticket office, exhibition area, game area are spread on many locations, and all of the locations are belong to the virtual POI of the entertainment agency. In calculating the stay time, the stay time of all locations of the virtual POI can be accumulated in order to determine if the virtual POI is the POI of the user.

In another point of view, the feature of the stay time of all locations of the virtual POI can be accumulated can also have the effect of confirming the true POI of the user to avoid misjudging of the POI. For example, when a ticketing of an entertainment agency is closed to roadside, the user select this location to meet with a person, in the footprint Information (If), after accumulating the stay time of each location of the POI, only the stay time at ticketing location of the virtual POI is existed, the stay time of the other locations in the virtual POI is not existed. The user may stay insufficient time in the other locations of the virtual POI so as to decrease misjudgment of the entertainment agency as the POI of the user.

About how to exclude misjudgment of POI, in one embodiment, the present invention can determine the footprint information (If) of multiple user, and calculating the number of the users at one location from the footprint information (If). The POI tracking analysis system of the present invention can compare the number of the users with the number of visitors allowed of POI corresponding to this location. When the number of the users in this location is higher than the number of visitors allowed of POI, determining that the POI is not the POI of these users. The purpose of this technology is to avoid factors such as traffic jams, holidays, or special events to cause that the users at this location are suddenly increase, avoiding that the stay time of the user is increased so as to misadjust the location as the POI of the users.

About excluding the misjudgment of POI, in one embodiment, the present invention provides an excluding technology. When determining a location as the POI, before and after a preset time, the user move a distance longer than a preset distance, the system destemming that the location is not the POI of the user. The misjudgment situation may be based on two reasons. One is function failure of detecting an external positioning signal that is the positioning function is not precise. The location detected may instantly move at high speed so that the location information cannot be used for determining the POI. The other reason is the affection of Plug-in program, the positioning function is modified. That is, misjudging the user instantly move at high speed, wherein, the location information obtained is not correct. Based on the excluding technology, the location and the POI determined by the present system will have high credibility, greatly reduce the possibility of mistakes and human misleading.

Besides except of using single stay time for determining the POI, the POI tracking analysis system can determine the stickiness degree of the user to the POI according to frequency of determining a specific location as the POI of the user. Besides, the above frequency, in one embodiment, a cumulative time for visiting the location in a unit time can also be used for determining the stickiness degree of the POI of the user.

In one embodiment, the required time for basic activity of partial POI can be adjusted according to Season, climate change, or holiday. About the required time for basic activity, the required time for basic activity in hot pot restaurant in winter will be longer than, the required time for basic activity in hot pot restaurant in summer. In another embodiment, the required time for basic activity in ice shop in summer is longer than the required time for basic activity in ice shop in winter. In another example, the required time for basic activity in department stores or stores on holiday is longer than the required time for basic activity in department stores or stores on weekdays. About the capacity on the number of people, on holiday, the turnover rate is faster and guests are more willing to wait so that the capacity on the number of people can higher than normal work and school days. The system can adjust the required time for basic activity according to actual situation, not limited to the above embodiment.

In one embodiment, the POI tracking analysis system can proactively provide activity information or recommendation information to the user according to the POI of the user stored in the historical information storage unit 13. For example, when the user reaches near the POI, the system can proactively provide the activity information or recommendation information. Or, when the store of the POI stops operations, rest, or redecorate, the system can proactively provide near POI having the same attribute for the user to consider and select. In one embodiment, the user can search the attribute classification in the system; the system can provide suggestion according to the POI data stored in the historical information storage unit 13 to provide suggestion. For example, providing the closest POI in the sub-category of attribute classification, or the closest POI in the same attribute classification, depending on the requirement of the user.

In another point of view, the present invention provides a people flow analysis system 20. The people flow analysis system 20 includes: multiple footprint judgment units 21 for receiving location information of multiple users, User(1), User(2), . . . User(m), and respectively determine individual footprint information If(1), If(2), . . . If(m) of the multiple users, User(1), User(2), . . . User(m). The footprint information If(1), If(2), . . . If(m) include multiple locations and time information at each location of each of the multiple users, User(1), User(2), . . . User(m); a historical information storage unit 22 for storing the footprint information If(1), If(2), . . . If(m) of the multiple users, User(1), User(2), . . . User(m); and a people flow analysis unit 23 analyzes a people flow status at different time of each location according to the footprint information If(1), If(2), . . . If(m) of the multiple users. Wherein, the people flow status at different time of each location maybe different, for example, the density of the people flow status is high at lunch and dinner time of a restaurant and the density of the people flow status is low at a non-meal time.

In one embodiment, the people flow analysis system 20 can provide people flow guidance suggestions, advertising hot spots suggestions, indoor air-conditioning arrangements suggestions, commercial expansion suggestions, warning information, or the most suitable path to the target location. Wherein for people flow guidance suggestions, according to the spread of the epidemic, crowds entering and exiting in the large gathering, or disaster escape and evacuation, recommending individual users to enter and exit in order to evacuate the flow of people or avoid high-density areas. For the advertising hot spots suggestion, for example, according to the people flow density or the attributes of POI of the users, recommending to set the hot spot of the advertisement or the attribute classification of this advertisement to achieve the advertising effect that is accurately targeted to the target user. For indoor air-conditioning arrangements suggestions, according to the density of people flow at a location, dynamically adjust the intensity of the air conditioner (for example, increase the intensity of the air conditioner when the people flow density increases, or reduce the intensity of the air conditioner when the people flow density decreases, so as to improve the quality of air conditioners flexibly and instantly, and improve energy efficiency). For the commercial expansion suggestions, according to the people flow density and the attributes of related POI, recommending the location for expanding store or the attributes of the expanding store. The warning information, for example, recommending the users to avoid areas or routes with high crowd density (for example, considering factors such as avoiding immune disease infection, or crowded evacuation routes) or too low crowd density (for example, considering factors such as poor public security, poor road conditions, etc.). For the most suitable path to the target location, for example, in a warehouse, the system provides an optimal path to avoid crowded areas or paths according to the target location, reducing the time for dodging crowds or waiting to give way in order to quickly reach the target location.

In the figure, the information delivery order of the historical information storage unit 22 and the people flow analysis unit 23 can be regulated according to requirement. For example, the people flow analysis unit 23 can receive the footprint information If(1), If(2), . . . If(m), and conducting a people flow analysis, then storing to the historical information storage unit 22. Or, the historical information storage unit 22 and the people flow analysis unit 23 can pass information back and forth. The content in the figures is only schematic, and the arrangement can be changed according to actual requirement.

In another embodiment, the present invention provides a people flow analysis system 30. Comparing to the people flow analysis system 20 described above, the people flow analysis system 30 further includes a POI analysis unit 24. The POI analysis unit 24 compares a stay time or a virtual object visiting record of each location in the footprint information If(1), If(2), . . . If(m) of each user User(1), User(2), . . . User(m) with a judgment threshold corresponding to POI, and determining if the location is the POI of at least one user according to a comparing result. The related information of POI can also be integrated into the judgement process of the people flow analysis unit 23 in order to determine the classification of POI of users in the people flow. The footprint information If(1), If(2), . . . If(m) of users User(1), User(2), . . . User(m) can be stored in the historical information storage unit 22 through the POI analysis unit 24. Or, the footprint information If(1), If(2), . . . If(m) can be directly stored in the historical information storage unit 22 (that is, not passing through the POI analysis unit 24). The judgement method of the POI can refer to the description in the above embodiment.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A point of interest tracking analysis system, comprising:
a footprint tracking unit, used for detecting a footprint information of an user, wherein, the footprint information includes multiple locations and a stay time of each of the multiple locations, or a virtual object visiting record of the user at one of the multiple locations;
a point of interest (POI) analysis unit, used for comparing the stay time or the virtual object visiting record at each of the multiple locations with a judgment threshold corresponding to each of the multiple locations for determining whether each of the multiple locations is a point of interest of the user or not; and
a historical information storage unit, used for storing each point of interest of the user.

2. The point of interest tracking analysis system according to claim 1, wherein the footprint tracking unit is used for detecting an indoor footprint information or an outdoor footprint information of the user.

3. The point of interest tracking analysis system according to claim 1, wherein the point of interest includes commercial organizations, tourist attractions, public agencies, coordinates of transportation facilities, storage spaces in stores or warehouses.

4. The point of interest tracking analysis system according to claim 1, wherein the virtual object visiting record is an operation time, a reading record, a positive review, a photo record, a video reposting action of an augmented reality object about the point of interest.

5. The f point of interest tracking analysis system according to claim 1, wherein the judgment threshold of the POI is a required time for basic activity, wherein when the stay time of the user at the location is longer than the required time for basic activity, the location is the POI of the user.

6. The point of interest tracking analysis system according to claim 5, wherein the point of interest tracking analysis system determines the footprint information of multiple user, and calculating the number of the users at the location, compares the number of the users with the number of visitors allowed of POI corresponding to the location, when the number of the users in this location is higher than the number of visitors allowed, determining that the POI is not the POI of these users.

7. The point of interest tracking analysis system according to claim 1, wherein the location of the POI is a three-dimensional location information.

8. The point of interest tracking analysis system according to claim 1, when determining a location as the POI, before and after a preset time, the user move a distance longer than a preset distance, the system destemming that the location is not the POI of the user.

9. The point of interest tracking analysis system according to claim 1, wherein the multiple locations can correspond to a same virtual POI, and the point of interest tracking analysis system accumulates the stay time of all locations of the virtual POI in order to determine if the virtual POI is the POI of the user.

10. The point of interest tracking analysis system according to claim 1, wherein the point of interest tracking analysis system proactively provide an activity information or a recommendation information to the user according to the POI of the user stored in the historical information storage unit.

11. A people flow analysis system, comprising:
multiple footprint judgment units for respectively determining individual footprint information of multiple users, wherein the footprint information includes multiple locations and time information at each location of each of the multiple users;
a historical information storage unit for storing the footprint information of the multiple; and
a people flow analysis unit analyzing a people flow status at different time of each location according to the footprint information of the multiple users.

12. The people flow analysis system according to claim 11, the people flow analysis system can provide people flow guidance suggestions, advertising hot spots suggestions, indoor air-conditioning arrangements suggestions, commercial expansion suggestions, warning information, or the most suitable path to the target location according to the people flow status.

13. The people flow analysis system according to claim 11, the footprint information includes multiple locations and a stay time of each of the multiple locations, or a virtual object visiting record of the user at one of the multiple locations; the people flow analysis system further includes a POI analysis unit, and the POI analysis unit compares a stay time or a virtual object visiting record of each location in the footprint information of each user with a judgment threshold corresponding to POI, and determining if the location is the POI of at least one user according to a comparing result.
